(19) United States
(12) Patent Application Publication
(10) Pub. No.: US 2011/0287786 A1
(43) Pub. Date: Nov. 24, 2011

(54) Mobile coaching distribution system

(76) Inventor: Chris Cassapakis, Escondido, CA (US)

(21) Appl. No.: 12/800,584

(22) Filed: May 18, 2010

(51) Int. Cl. H04W 4/02

(52) U.S. Cl. 455/456.3

(57) ABSTRACT

A mobile coaching distribution system that sends various types of persuasive Content that many include, but not be limited to, advice, reminders and interventions relating to healthcare, physical and mental wellness, treatment adherence, professional development or personal development, over a cellular network. There are three components of mobile coaching: time and place and frequency. The mobile coaching distribution system enables a subscriber to control the location at which the content is received. The user may specify up to a certain number (say 10) of different geolocations. The geolocations are specified by opening an application in the provided mobile client and pushing a button. Through either data or SMS connection the longitude and latitude of the location are uploaded into a server. The server recognizes the phone number or IMEI of the phone and stores the location into a subscriber-specific location database. The subscriber can go on a website and modify or augment the database of locations that he has entered through the application. The content that can be delivered may include audio, SMS, data or pictures. The content, the frequency and timing of its delivery and the radius around the pre-selected locations can be determined either by the subscriber to the service, or by a website administrator for the service provider.

### CROSS REFERENCES TO RELATED APPLICATIONS

The present application is a continuation-in-part of US patent application titled BROADCASTING PRE-RECORDED CONTENT DIRECTLY INTO SUBSCRIBERS′ CELLULAR VOICE-MAIL BOX, docket number CC2009U1, filed on Apr. 14, 2009. The present invention is related to and claims priority to CC2009U1, which is incorporated herein in its entirety by reference for all purposes.

### BACKGROUND

1. Technical Field

The present invention relates generally to broadcasting messages and more specifically to broadcasting a coaching message to several different subscribers using a content delivery system based on the current geolocation of the user.

2. Related Art

There is a huge population all around who are being treated for wide variety of maladies. These maladies range from heart diseases, obesity, substance abuse, mental illnesses to other physiological and psychological problems. In addition, there is also a huge population segment that engages in various physical, recreational, religious, sports, and other recreational activities. These activities may range from physical activity prescribed for weight management, health maintenance, various chronic health conditions, physical or mental rehabilitation to activities pursued for entertainment or stress reduction.

There is also a significant demand for medical and psychological experts, practitioners, financial advisors, and other learned and otherwise scholarly people who provide mobile coaching to these people. It is hard for the practitioners, experts and other learned and otherwise scholarly people to identify and reach the abovementioned population and provide this population with applicable coaching at a time and place that such coaching would be most impactful and beneficial.

While the abovementioned population can only visit the appropriate experts, such as healthcare professionals, counselors or coaches only occasionally (e.g. once in a week or a month) they may need various types of intervention, reminders, follow up or persuasion (collectively referred to herein below as Content) delivered to them on a regular and more frequent basis. There is a problem in delivering such coaching/persuasion regularly or frequently to have a significant impact on the people that require such coaching. There is a problem with such people often being disorganized and not being able to attend sessions arranged for them for instructions, coaching and mentoring. There is a problem with reaching an expert or counselor over a telephone to seek timely advice and assistance.

There is a problem often encountered by experts in delivering such coaching at predetermined frequencies and times, when the recipients are either too busy or unwilling to keep appointments, or visit their clinics, or visit assigned websites for information and help. Thus, there is a need to help recipients stay on their prescribed treatment plan and follow the advice given by medical professionals. Generally the patients need to be incentivized to maintain the regiment they need to follow, to achieve their personal goals (related to healthcare, mental health, behavioural change, professional development or personal development). Without such advice or help, the abovementioned recipients may default and may forget to follow their prescribed regiment.

Some mobile phones are capable of determining the geolocation of the current user. Such geolocations can be either stored locally or sent to a server. However, most users do not employ services wherein such geolocation information is put to good use. Some people use such geolocation information to navigate to specific places, such as a movie theatre. But very few applications or services exist that meaningfully employ geolocations.

A patent application in the USPTO, titled “Systems and methods for location dependent information download to a mobile telephone”, Ser. No. 10/334,538, filed on Jan. 1, 2003, provides some details of using GPS based geolocations for mapping information, that can be accessed from a mobile device. It discloses a method of providing information to a mobile device, wherein a server provides mapping information when a user initiates retrieval of mapping information. One aspect to note is that the user has to initiate such retrieval of mapping information. It is not automatic. No customization per each user seems to be supported. The Ser. No. 10/334,538 patent application is not relevant to the current invention, as the current invention is more geared towards “automatically” monitoring user behaviour and automatically delivering coaching messages (and not maps) employing a collection of user-specified custom geolocations. The Ser. No. 10/334,538 patent application does not teach what the present invention teaches for automatic delivery of coaching information from experts to users based on their current geolocations.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic diagram illustrating a mobile coaching distribution system; wherein a plurality of receivers' mobile devices, based upon their current geolocations, receive various types of mobile coaching information from their respective content providers;

FIG. 2 is a schematic diagram illustrating components of the receiver's mobile device 207 of the FIG. 1;

FIG. 3 is a schematic diagram illustrating exemplary components of the m-coaching server(s) of the FIG. 1;

FIG. 4 is a schematic diagram illustrating components of the mobile coaching broadcast management server of the FIG. 1;

FIG. 5 is a perspective block diagram of an exemplary delivery manager, that is similar to the delivery manager described in FIG. 1;

FIG. 6 is a flow diagram illustrating exemplary operations of the mobile client of FIG. 2 in detail; and

FIG. 7 is a flow diagram illustrating exemplary operation of the mobile coaching broadcast management server of FIG. 4, in detail.

### DETAILED DESCRIPTION OF THE DRAWINGS

The present invention provides for automatically monitoring of user movements for delivery of relevant & appropriate content to the user. It teaches monitoring geolocations automatically as they are reported from a user's mobile device, and then comparing it to a user registered collection of geolocations to automatically deliver relevant coaching messages to the user's mobile device when a match (of geolocations) is found.

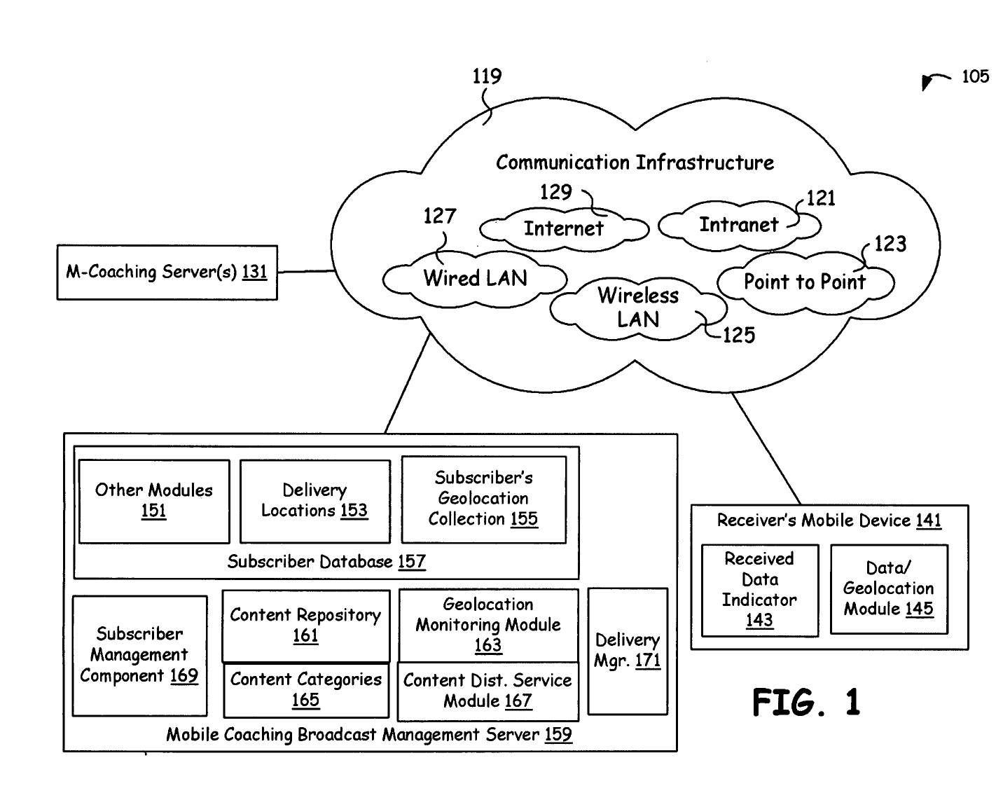

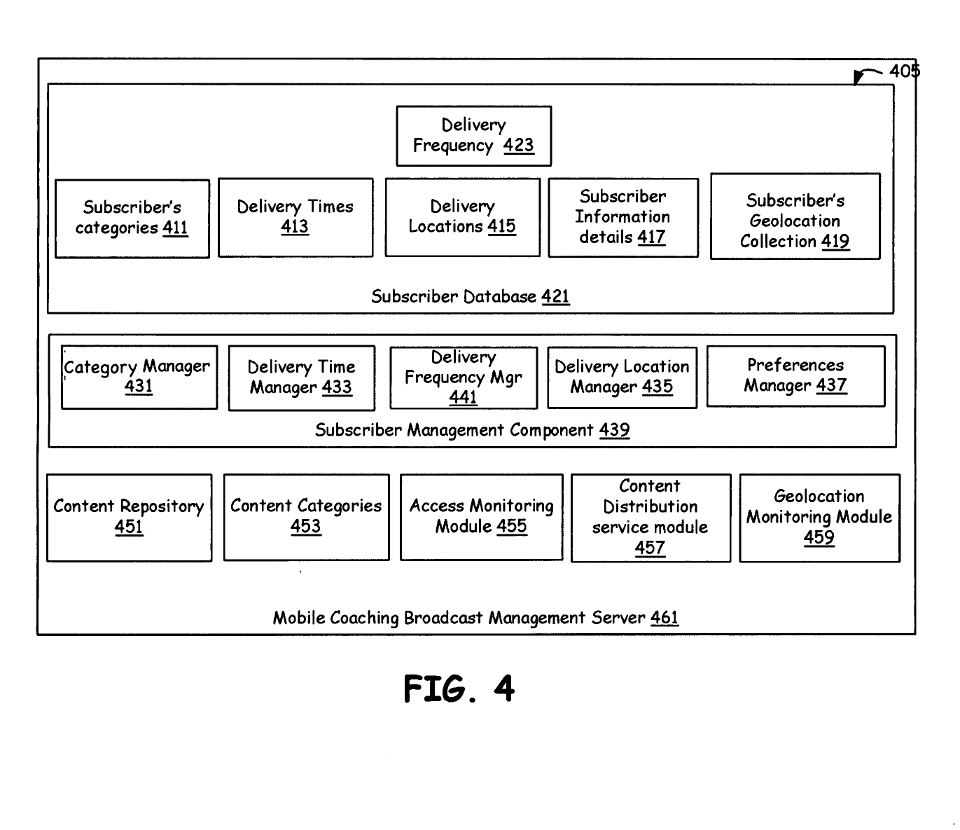

FIG. 1 is a schematic diagram illustrating a mobile coaching distribution system 105; wherein a plurality of receivers' mobile devices 141, based upon their current geolocations, receive various types of mobile coaching information from their respective content providers. To perform the abovementioned functionalities, the mobile coaching distribution system 105 consists of a mobile coaching broadcast management server 159, which is communicatively coupled to a plurality of receiver's mobile devices 141 and a plurality of m-coaching server(s) 131. The mobile coaching broadcast management server 159, in turn, consists of a subscriber database 157, containing delivery locations 153, subscriber's geolocation collection 155, and other modules (described in additional detail in the FIG. 4). Moreover, the mobile coaching broadcast management server 159 also consists of a subscriber management component 169, content repository 161, content categories 165, geolocation monitoring module 163 and content distribution service module 167 and a delivery manager 171.

In general, the mobile coaching broadcast management server 159, via the m-coaching servers 131 help in disseminating expert advice and/or information aimed at assisting the users in attaining their goals as they pertain to healthcare, mental health, behavioural transformation, nutrition and exercise, professional development or personal development.

In general, the geolocation monitoring module 163 monitors changes in the geolocations (comprising current location of users) and determines if any specific content needs to be delivered to the user/subscriber on his receiver's mobile device 141. For example, the receiver's mobile device 141 reports changes to the geolocations of the user of the receiver's mobile device 141 to the mobile coaching broadcast management server 159, which then determines if the user is in a specified location (that may be previously registered by the useror by a service provider) and if any corresponding/applicable content needs to be delivered to the user when he/she is at that geolocation.

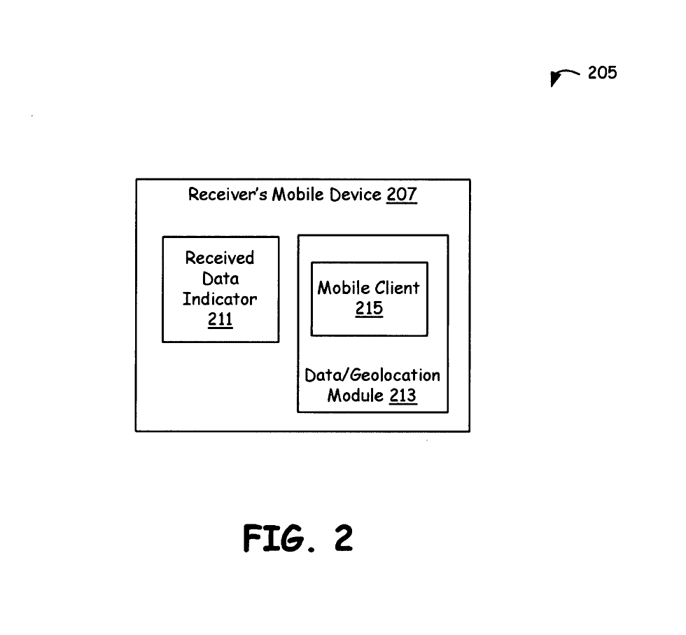

Further, the receiver's mobile device 141 consists of received data indicator 143 and data/geolocation module 145. The communicative coupling between the receiver's mobile device 141 and the mobile coaching broadcast management server 159 is done via a communication infrastructure 119, made up of one or more of wireless Internet 129, wired Intranet 121, wired LAN 127, wireless LAN 125 and/or point to point communication infrastructure 123. Other details of the mobile coaching broadcast distribution system 105 are appropriately discussed with reference to the FIG. 2 through FIG. 4.

The functionalities of the mobile coaching distribution system 105 begins when the data/geolocation module 145 of the receiver's mobile device 141 opens up an application (at the very beginning of the installation of the data/geolocation module 145, and anytime thereafter), that allows the user to key in a (for example, a fixed number of) geolocations of the user's choice. A fixed number of geolocations for a user, for example, may be 10 locations (areas such as home, favorite grocery store, closest fast-food restaurant, gym, etc). These locations may also be stored via a computer based application (or browser based application) that connects to the mobile coaching broadcast management server 159. These geolocations are then stored in the subscriber's geolocation collection 155. In addition, the users of the receiver's mobile devices 141 are also allowed to sign up to the content providers of their choice, among a plurality of available/signed up content providers, some of whom may employ servers or systems external to the mobile coaching broadcast management server 159.

In general, the various content providers store their mobile coaching content in the content repository 161, segregated into pre-determined content categories 165. For example, the users can sign up to receiving mobile coaching content from a plurality of categories such as healthcare or personal development.

The geolocation monitoring module 163 continues to monitor the whereabouts of each of the plurality of receiver's mobile devices 141, based upon the geolocations (subscriber's preferences of favourite store, favourite restaurant, etc.) stored in the subscriber's geolocation collection 155. Then, when a receiver's mobile devices 141 enters a pre-determined radius of a specific location stored in the subscriber's geolocation collection 155 (such as when the receiver's mobile devices 141 reports his current location), the content distribution service module 167 verifies if it needs to send the user an appropriate type of content and if so, sends the appropriate message.

In one embodiment, when the user of a receiver's mobile device 141 signs up for services from a plurality of providers associated with the mobile coaching broadcast management server 159, the user pays fees, and in turn, receives an application to be run by the receiver's mobile device 141. The application allows the user to enter up to a certain number of geolocations (such as favorite store, restaurant etc.) into the mobile coaching broadcast management server 159. Such data entry of the geolocations can also be conducted via a computer that directly logs (or connects using standard techniques) into the mobile coaching broadcast management server 159. Once this is accomplished, the user also subscribes to one or more types/categories of content via the mobile phone application or employing an independent computer that logs into the mobile coaching broadcast management server 159.

The mobile coaching content providers, for example, may be experts who deal with heart diseases, obesity, mental illnesses, other physiological and psychological problems or other scholars who deal with various religious, sports, or some other recreational activities.

In general, the receiver's mobile device 141 is capable of determining current geolocations of a user to the mobile coaching broadcast management server 159, such as when a user moves from one location to another. The mobile coaching broadcast management server 159 determines if the user's current location is one of the pre-registered geolocations. If it determines that to be the case, it locates relevant content (if any) and sends it to the receiver's mobile device 141, optionally via the m-coaching servers 131.

The m-coaching servers 131 serve as a store-and-forward voicemail delivery system in one embodiment, and a data and message delivery system capable of supporting messaging inboxes for a plurality of users in another embodiment.

In one embodiment, the receiver's mobile device 141 is capable of determining if a user has entered or approached one of the pre-registered geolocations. A client module within the receiver's mobile device 141 keeps on observing the geolocations (based upon the navigational coordinates, for example) and when it enters the radius of one of the geolocations registered (that is also stored in the mobile coaching broadcast management server 159), it sends a message to the mobile coaching broadcast management server 159. Then, the mobile coaching broadcast management server 159 verifies and monitors any need to send an appropriate content/message to the user, and if so, sends one. The mobile coaching broadcast management server 159 also monitors if the content/message has been acknowledged or opened by the user and then can send a reminder, if not opened within a pre-specified time period.

In general, the subscriber database 157 contains subscriber specific information, subscriber preferences, subscriber details, subscriber selections of categories of content, etc. For example, the subscriber database may contain subscriber name, email address, phone numbers, credit card information, subscription duration, referral information, content provider references, content category preferences, delivery preferences, delivery time window, delivery locations, and tithing preferences. The subscriber management component 169 facilitates subscriber management.

In one embodiment, the broadcast of the messages by the mobile coaching broadcast management server 159 may not require any human intervention for the delivery of geolocation related content to a user. The user may require facilities to subscribe to different services that provide periodic as well as location based messages that are provided. Content delivered to subscribers may include SMS, picture or audio-visual messages such as news of specific interest to the subscriber, health-related reminders, updates on entertainment stories, inspirational reminders, instructional information, etc.

In general, the present invention employs a location-based trigger and subsequent delivery of content. The user can specify several different geolocations. The geolocations are specified by opening the data/geolocation module 145 in the receiver's mobile device 141 and pushing a button, for example. Through either data or SMS connection the longitude and latitude of the location are uploaded from the receiver's mobile device 141 into mobile coaching broadcast management server 159. The mobile coaching broadcast management server 159 recognizes the phone number or IMEI of the receiver's mobile device 141 and stores the location into the subscriber database 157. The subscriber can go on a website associated with the mobile coaching broadcast management server 159 and modify the collection of geolocations that he has entered via the receiver's mobile device 141. The subscriber can also modify the geolocations stored in the subscriber database 157 via the receiver's mobile device 141.

The content that can be delivered may include audio, SMS, data or pictures. The content, the frequency of its delivery and the radius around the pre-selected locations can be determined either by the subscriber, or by a website administrator for the service provider associated with the mobile coaching broadcast management server 159.

In one embodiment, a subscriber's receiver's mobile device 141 uses the data channel to pinpoint the current location of the receiver's mobile device 141 to the mobile coaching broadcast management server 159. This activity can happen within a configurable frequency from an administrative console (every 5, 10, 15 etc. minutes). Once the receiver's mobile device 141 enters a pre-configurable geo fence around one of the pre-selected geolocations it triggers the delivery of content by the mobile coaching broadcast management server 159 into the receiver's mobile device 141.

In another related embodiment, a service administrator can preselect (pre-determine) geolocations for a group of users and set these geolocations in a group-specific database in the mobile coaching broadcast management server 159 where a mobile identifier (phone number, IMEI, etc.) for of each member of the group is also provided.

In one embodiment, the present invention provides the mobile coaching distribution system 105 that comprises a mobile coaching broadcast management server 159 communicatively coupled to a plurality of mobile devices. The mobile coaching broadcast management server 159 comprises the geolocation monitoring module and the content distribution service module. The geolocation monitoring module gathers current geolocations from each of the plurality of mobile devices, wherein the plurality of mobile devices automatically report their current geolocations to the geolocation monitoring module without user involvement. The content distribution service module automatically delivers a content to each of the plurality of mobile devices based on the current geolocations automatically reported by them. The current geolocation comprises navigational coordinates that identify a predetermined area. The predetermined area is limited to geolcations previously registered and the navigational coordinates are GPS based coordinates in one embodiment. The predetermined area is setup by the users of the plurality of mobile devices.

In a related embodiment, content is a short message service comprising coaching instructions. Content can also be an audio-visual message or a picture message.

In another related embodiment, the mobile coaching broadcast management server 159 comprises also the delivery location manager that manages preregistered areas for each of the plurality of mobile devices, wherein the preregistered areas are defined in terms of geolocations. The mobile coaching broadcast management server also comprises the subscriber database which contains a plurality of preregistered delivery locations belonging to user's of each of the plurality of mobile devices. The subscriber's geolocation collection stores the plurality of preregistered delivery locations and associates them with one or more coaching content providers. The geolocation collection is uploaded by the users of each of the plurality of mobile devices to the mobile coaching broadcast management server 159.

FIG. 2 is a schematic diagram illustrating components of the receiver's mobile device 207 of the FIG. 1. The receiver's mobile device 207 consists of a received data indicator 211 and data/geolocation module 213. The data/geolocation module 213 in turn consists of a mobile client 215 that interacts with the mobile coaching broadcast management server 159.

Initially, the user (subscriber) downloads and installs a patch of software (or an update package) that contains the received data indicator 211 and data/geolocation module 213 (and the mobile client 215). Once installed and invoked, the software allows the user to login to the mobile coaching broadcast management server (159 of FIG. 1) and enter geolocations of choice. The mobile coaching broadcast management server 159 allows only a certain limited number of locations to be entered. In one embodiment, the geolocations are nothing more than navigational coordinates that reflect a radius around a certain area of choice. These navigational coordinates may also be chosen directly from the menu entered beforehand in the mobile coaching broadcast management server 159. A service charge may have to be paid for this service. In a related embodiment, there is no limit to the number of geolocations of interest a user can enter/register with the mobile coaching broadcast management server 159.

Once the coordinates are entered and registered by the user, the mobile client 215 allows the user to login to the mobile content broadcast management server and select from a menu of Content providers that are entered beforehand in the mobile content broadcast management server. The Content providers may also charge a certain amount for their services; and in some cases, may come at no cost to the user or subscriber. Then, the receiver's mobile device 207 is ready for use. When the user (or, the receiver's mobile device 207) enters one of the selected geolocations, the receiver's mobile device 207 (or the mobile client 215) sends an indication to the mobile coaching broadcast management server. The mobile coaching broadcast management server verifies that the geolocation of the user falls within the predetermined radius of any of the locations entered in the subscriber's geolocation collection module (155 of FIG. 1).

If so, the mobile coaching broadcast management server 159 sends an appropriate message (which may also be customized for a particular category of subscribers, based upon their preloaded preferences) and the mobile client 215 receives it. The received data indicator 211 displays an indication (which may be a tone and/or visual indication) to let the user know a message has been delivered. When the user opens up the message and goes through the message, the mobile client 215 again sends an appropriate indication to the mobile content broadcast management server, confirming that the message has been read by the user. If not, after some time, the received data indicator 211 again displays an indication. The content delivered to users may contain short message services, voice mails, picture mails, audio-visual messages (such as a MP3, or MPEG data messages).

In one embodiment, the mobile client 215 provides a direct access to the subscriber's geolocation collection module 155, of the mobile coaching broadcast management server 159. In another embodiment, a user can employ a computer/PC to directly enter geolocations of interest into the geolocation collection module 155.

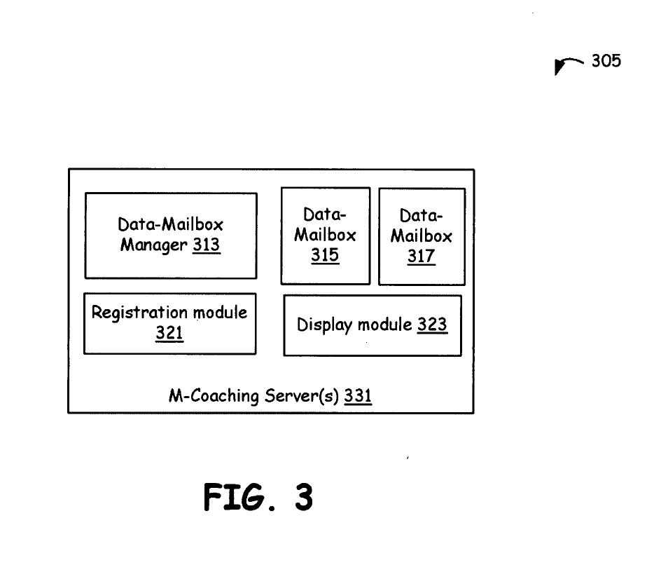

FIG. 3 is a schematic diagram illustrating exemplary components of the m-coaching server(s) 331 of the FIG. 1. The m-coaching server 331 consists of a data-mailbox manager 313, plurality of data-mailboxes 315, 317, registration module 321 and display module 323.

The data-mailbox manager 313 manages creating content/messages that are considered to be data or mail (sometimes referred to as data-mail) and accessing such content, etc. In particular, it supports sending voicemail and voicemail with data to the data mailbox 315, 317 of one or more users based on the current geolocations of the users. It allows a new message to be uploaded, deleted or modified, either by the subscriber or by the content providers. It also allows the user (help and advice content provider) to upload help and advice contents based upon geolocations.

The registration module 321 facilitates registration of new data-mailboxes for each of the subscribers, or their categories. For each of the subscribers, or their categories, one data-mailbox, such as the 315 or 317, may be assigned. The display module 323 displays available data-mail for a subscriber. When a subscriber gets a new data-mail in his data-mailbox, the m-coaching server 331 causes a received data indicator (211 of FIG. 2) in the receiver's mobile device (207 of FIG. 2) to be set.

FIG. 4 is a schematic diagram illustrating components of the mobile coaching broadcast management server 461 of the FIG. 1. The mobile coaching broadcast management server 461 is central to the operations of the present invention, and it contains a subscriber database 421, subscriber management component 439, content repository 451, content categories 453, access monitoring module 455, content distribution service module 457 and geolocation monitoring module 459. The subscriber's database 421 in turn contains subscriber's categories 411, delivery times 413, delivery frequency 423, delivery locations 415, subscriber information details 417 and subscriber's geolocation collection 419. The subscriber's management component 439 contains category manager 431, delivery time manager 433, delivery frequency manager 421, delivery location manager 435 and preferences manager 437. The mobile coaching broadcast management server 461 is communicatively coupled to the receiver's mobile devices (207 of FIG. 2) and m-coaching server(s) (331 of FIG. 3).

The subscriber management component 439, initially, allows logging in by a receiver's mobile device (207 of FIG. 2) and sends a software patch (or update package) that contains a mobile client (215 of FIG. 2) to be installed. With the subscriber's assistance, then, the subscriber management server 439 verifies if the software patch is properly installed. At the same time, the subscriber management server 439 opens up a database in the subscriber's information details 417 (within the subscriber's database 421) and enters all of the subscriber's personal information such as name, username, password, and date of birth. Also, the subscriber management server 439 opens up a database within the subscriber's geolocation collection 419 and allows the subscriber to enter a certain number of locations. The locations may be one of preloaded areas or alternatively, the subscriber may enter the details (such as navigational coordinates) by oneself.

In one embodiment, a subscriber initially accesses the database 421 and enters data into the subscriber information details 417. Such data may contain name, username, password, phone number, content type, delivery time, delivery frequency and, if known, delivery locations. The delivery locations can also be entered by the subscriber via the receiver's mobile device 207, by uploading navigational coordinates from the receiver's mobile device 207 into the subscriber's geolocation collection 419.

The delivery location manager 435 manages the delivery location lists preloaded in the delivery locations 415, while delivery time manager 433 manages the delivery times preloaded in the delivery times 413 and delivery frequency manager 441 manages the delivery frequencies preloaded in the delivery frequencies 423. The preferences manager 437 manages the user preferences while category manager 431 maintains the subscriber's categories 411. User preferences comprise of user's default mode of receiving content, default number of reminders to read content, acknowledgement needs, etc. The category manager 431 facilitates creation and modification of categories of content, and management of lifecycle issues related to such categories.

Additionally, the mobile coaching broadcast management server 461 incorporates a content repository 451 and content categories 453. The content repository 451 maintains all of the SMS, voice, picture, audio-visual messages that are uploaded from the content provider's server(s). These are maintained on the basis of categories by the content category module 453.

Similarly, to maintain the monitoring of the plurality of receiver's mobile devices and manage distribution of the Content stored in the content repository 451, the mobile coaching broadcast server 461 also contains an access monitoring module 455, a content distribution service module 457 and geolocation monitoring module 459. The content distribution service module 457 sends an appropriate message (and even customizes, if necessary, based upon the Content provider's or the subscriber's preferences), when the user enters a preloaded geolocation. The access monitoring module 455 verifies that the subscriber has viewed the message and if not sends a periodic reminder.

The geolocation monitoring module 459 constantly (or periodically, based on configuration) monitors the geolocations of the plurality of receiver's mobile devices and identifies when a subscriber has moved into the radius of one of the entered geolocations, in one of two ways: (i) the subscriber's mobile device uses the data channel to pinpoint the location of the mobile device and informs the mobile coaching broadcast management server 461; and (ii) a service administrator preselects (pre-determines) geolocations for a group of mobile devices and sets these locations in a group-specific database in the mobile coaching broadcast management server 461, where a mobile device identifier (phone number, IMEI, etc.) for of each subscriber of the group is also located. This process can happen within configurable frequencies from an administrative console (every 5, 10, 15 etc. minutes). Once the phone enters a pre-configurable geo-fence around one of the pre-selected geo locations it triggers the delivery of content into the mobile device.

In one embodiment, content is segregated by content provider, content type, and content modality. Other types of segregation are also contemplated.

The mobile coaching broadcast management server 461 manages subscriptions by a plurality of subscribers to a plurality of services available. It receives content for distribution to each of the plurality of subscribers as appropriate. It stores content in a content repository. It distributes the content to appropriate ones of the plurality of subscribers, based upon their current geolocations and a reference collection of geolocations that have been set up in advance. It causes a display of an indication of the availability of content, on a corresponding mobile device, that is associated with each of the plurality of subscribers. It monitors the retrieval of content by each subscriber of the plurality of subscribers. The plurality of subscribers setup particular geolocations during registration with the mobile coaching broadcast management server 461. The appropriate ones of the plurality of subscribers are those who have registered with a content provider during registration with the mobile coaching broadcast management server 461. In general, there are three components of mobile coaching that the mobile coaching broadcast management server 461 manages—time and place and frequency of coaching.

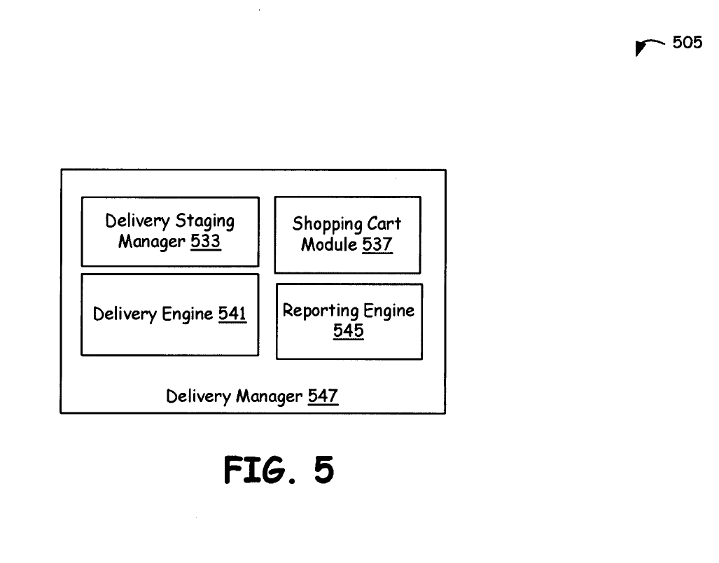

FIG. 5 is a perspective block diagram of an exemplary delivery manager, that is similar to the delivery manager described in FIG. 1. The delivery manager 547 comprises a delivery staging manager 533, a delivery engine 541, a shopping cart module 537 and a reporting engine 545. The delivery manager 547 makes it possible to schedule a time frame, frequency and multitude of locations for the delivery of content, wherein the schedule is subscriber specific, and the rules for delivery are executed by the delivery engine 541. The reporting engine 545 facilitates generation of reports for various content providers, and forwarding of such reports to those content providers or to external billing systems. The delivery staging manager 533 makes it possible to provided testing and staging services for content that need to be delivered to users. It facilitates caching of such staged content, as necessary.

The reporting engine 545 facilitates reporting of usage information to content providers, as individual users/subscribers are provided mobile coaching based on their geolocations (as they move about). The delivery engine 541 makes it possible to conduct rules-based delivery of mobile coaching information, wherein the rules are set either by the user or by the corresponding content providers.

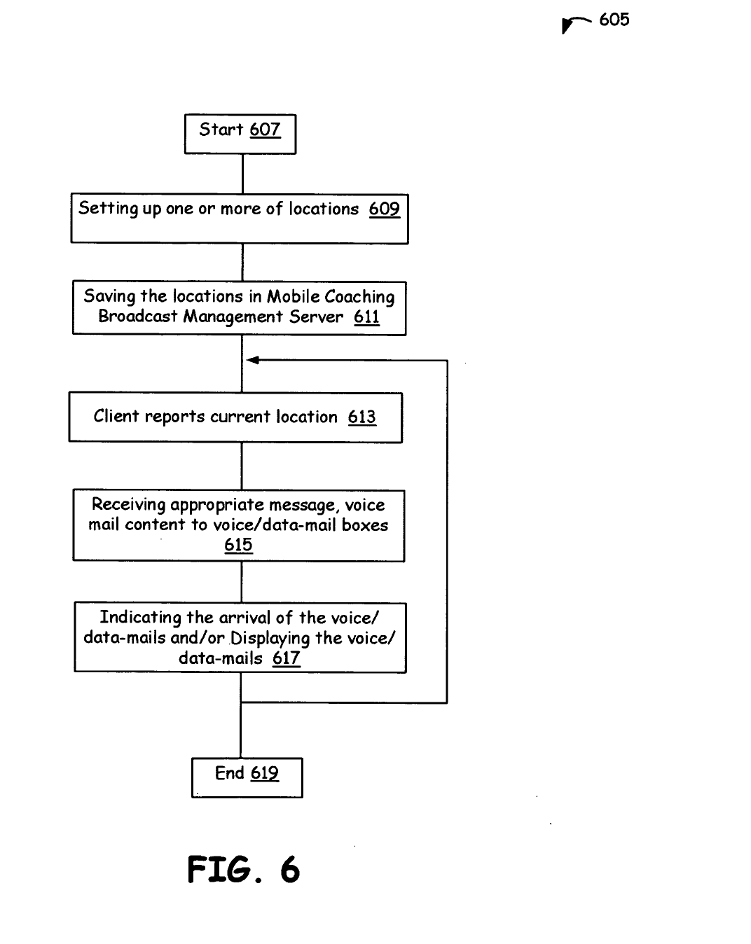

FIG. 6 is a flow diagram illustrating exemplary operations of the mobile client of FIG. 2 in detail. The operations of the mobile client starts at a start block 607. Then the mobile client identifies one or more locations of interest. Alternatively the user, via the mobile client, identifies these locations. At a next block 609, the mobile client uploads new locations to be saved in the mobile coaching broadcast management server 159. Note that the subscriber may directly log into the mobile coaching broadcast management server 159 and save the abovementioned locations or a service administrator preselects (pre-determines) geolocations for a group of mobile devices. Then, at a next block 611, the mobile client causes these locations to be saved in the mobile coaching broadcast management server 159. In one related embodiment, it directs the mobile coaching broadcast management server 159 to save them in a content provider-specific database in the mobile coaching broadcast management server 159.

At a next block 613, the mobile client sends the user's current locations to the server, and requests the server to determine if any mobile coaching content is to be delivered to the user. In one embodiment the client determines that the user has moved to a preregistered (previously set up) location and requests appropriate content. At a next block 615, the mobile client receives appropriate content from the voice/data-mail boxes associated with the user. At a next block 617, the mobile client indicates the arrival of the content via an audible or visible signal, as it receives notification of the availability of mobile coaching content for that user, based on the user's current location.

These processes of the blocks 611, 613 and 615 keep on repeating continually, and every time a user enters one of the preset locations, a message may be received by the mobile client. The functionality of the mobile client ends at an end block 619.

In one embodiment, at the start block 607, the user installs a mobile client into the mobile device, and after installation of the mobile client, the mobile sends a message back to the server indicating that the mobile client has been installed properly and is functional.

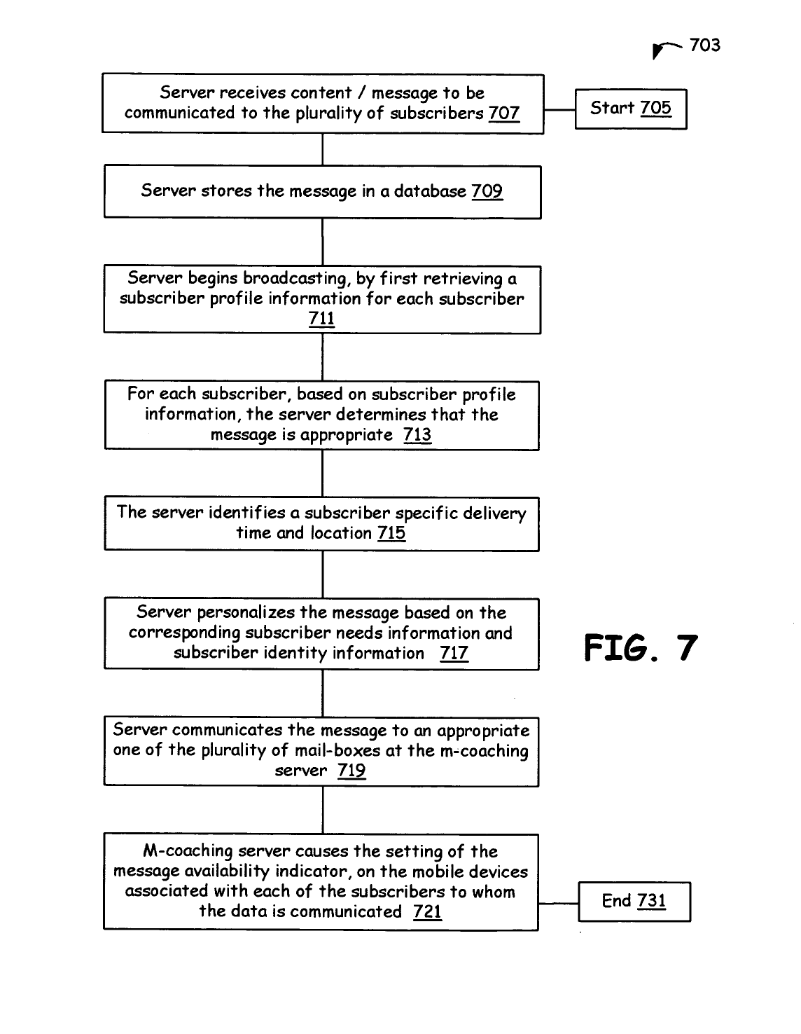

FIG. 7 is a flow diagram illustrating exemplary operation of the mobile coaching broadcast management server 461 of the FIG. 4, in detail. The operation begins at a start block 705, when content providers (if any) have made their mobile coaching content available for distribution. Then, at the next block 707, the mobile coaching broadcast management server 461 receives new or updated content from a content provider that is to be communicated to the plurality of subscribers, who have each subscribed to the content. At a next block 709, the mobile coaching broadcast management server stores the mobile coaching content in a database, along with associated locations where such content delivery will be relevant. Optionally, it also stores a list of subscribers to whom such content will be most appropriate.

At a next block 711, the mobile coaching broadcast management server begins broadcasting, by first retrieving a subscriber's profile information for each of the subscribers. At a next block 713, the mobile coaching broadcast management server 461 determines the appropriate content to be delivered to a specific subscriber based upon the subscriber's profile information and preferences. At a next block 715, the mobile coaching broadcast management server identifies the predetermined delivery time, frequency and location information for a specific subscriber.

At a next block 717, the mobile coaching broadcast management server 461 personalizes the mobile coaching content based upon the corresponding subscriber's needs information and subscriber identity information and preferences. At a next block 719, the mobile coaching broadcast management server 461 delivers the content to an appropriate one of the plurality of mail-boxes at the m-coaching server 131 for eventual delivery to a subscriber's mobile phone. At a next block 721, the m-coaching server 131 causes the setting of the message availability indicator (received data indicator), on the mobile devices associated with each of the subscribers to whom the data is communicated. Processing then terminates at an end block 731.

In general, a mobile coaching distribution system 105 built in accordance with the present invention sends various types of content over a mobile coaching system to a plurality of mobile users. There are at least three components of the mobile coaching system: time, place and frequency. The mobile coaching distribution system enables a subscriber to control the location at which the selected Content may be received. The user may specify up to a certain number (say 10) different geolocations. The geolocations are specified by opening an application in the provided mobile client and pushing a button. Through either data or SMS connection the longitude and latitude of the location are uploaded into the mobile coaching broadcast management server 159. The server 159 recognizes the phone number or IMEI of the phone and stores the location into a subscriber-specific location database. The subscriber can go to a website associated with the mobile coaching broadcast management server 159 and modify or augment the database of locations that he has entered through the application. The various types of content that can be delivered may include audio, video, SMS, data or pictures. The content, the timing and frequency of its delivery and the radius around the pre-selected locations can be determined either by the subscriber to the service, or by a website administrator for the service provider.

As one of ordinary skill in the art will appreciate, the term “geolocation” may refer to the practice of assessing the location, or to the actual assessed location, or to locational data associated with a user. As WikiPedia describes it, Geolocation can be performed by associating a geographic location with the Internet Protocol (IP) address, MAC address, RFID, hardware embedded article/production number, embedded software number (such as UUID, Exif/IPTC/XMP or modern steganography), invoice, Wi-Fi connection location, or device GPS coordinates, or other, perhaps self-disclosed information. One way to implement Geolocation is by automatically looking up an IP address on a WHOIS service and retrieving the registrant's physical address. Another way is for a mobile device to collect GPS coordinates from its GPS circuitry and record them or store them. It must be appreciated that Geolocation determination used herein also incorporates the meaning of Geocoding, which is the process of finding associated geographic coordinates (often expressed as latitude and longitude) from other geographic data.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A mobile coaching distribution system comprising:
a mobile coaching broadcast management server communicatively coupled to a plurality of mobile devices, comprising:
a geolocation monitoring module;
a content distribution service module;
the geolocation monitoring module gathers current geolocations from each of the plurality of mobile devices, wherein the plurality of mobile devices automatically report their current geolocations to the geolocation monitoring module without user involvement; and
the content distribution service module automatically delivers a content to each of the plurality of mobile devices based on the current geolocations automatically reported by them.

2. The mobile coaching distribution system of claim 1, wherein the current geolocation comprising navigational coordinates that identify a predetermined area.

3. The mobile coaching distribution system of claim 2, wherein the predetermined area is limited to geolocations previously registered and the navigational coordinates are GPS-based coordinates.

4. The mobile coaching distribution system of claim 2, wherein the predetermined area is setup by the users of the plurality of mobile devices.

5. The mobile coaching distribution system of claim 1, wherein the content is a short message service comprising coaching instructions.

6. The mobile coaching distribution system of claim 1, wherein the content is an audio-visual message.

7. The mobile coaching distribution system of claim 1, wherein the content is a picture message.

8. The mobile coaching distribution system of claim 1, wherein the mobile coaching broadcast management server further comprising:
a delivery location manager.

9. The mobile coaching distribution system of claim 8; wherein the delivery location manager manages preregistered areas for each of the plurality of mobile devices, wherein the preregistered areas are defined in terms of geolocations.

10. The mobile coaching distribution system of claim 1, wherein the mobile coaching broadcast management server further comprising:
a subscriber database comprising:
a plurality of preregistered delivery locations belonging to user's of each of the plurality of mobile devices; and
a subscriber's geolocation collection that stores the plurality of preregistered delivery locations and associates them with one or more coaching content providers.

11. The mobile coaching distribution system of claim 10, wherein the geolocation collection is uploaded by the users of each of the plurality of mobile devices to the mobile coaching broadcast management server.

12. The mobile coaching distribution system of claim 10, wherein the subscriber's geolocation collection is uploaded by a service administrator for a specific group of mobile devices.

13. A first mobile device comprising:
a received data indicator;
a data-geolocation module comprising:
a mobile client;
the mobile client sends current geolocations to a mobile coaching broadcast management server, when the user has moved to a predetermined location; and
the mobile client, in response to the current geolocations sent, receives an appropriate content from the mobile coaching broadcast server;
the received data indicator indicates the receiving of the appropriate content; and
the mobile client displays the received appropriate content.

14. The first mobile device of claim 13, wherein the appropriate content is provided by a content provider.

15. The first mobile device of claim 14, wherein the user registers during a registration activity with the mobile coaching broadcast management server that is associated with a content provider.

16. The first mobile device of claim 15, wherein the user sets up geolocations during the registration activity with the mobile coaching broadcast management server and subsequently receives mobile coaching instructions automatically from the mobile coaching broadcast management server.

17. A method performed by a mobile coaching broadcast server, the method comprising:
managing subscriptions by a plurality of subscribers to a plurality of services;
receiving content for distribution to each of the plurality of subscribers as appropriate;
storing content in a content repository;
distributing the content to appropriate ones of the plurality of subscribers, based upon their current geolocations and a reference collection of geolocations that have been set up in advance;
causing an indication of the availability of content, on an associated mobile device associated with each of the plurality of subscribers; and
monitoring the retrieval of content by each subscriber of the plurality of subscribers.

18. The method of claim 17, wherein the plurality of subscribers setup particular geolocations during registration with the mobile coaching broadcast server.

19. The method of claim 17, wherein the appropriate ones of the plurality of subscribers are those who have registered with a content provider during registration with the mobile coaching broadcast server.

20. The method of claim 17, wherein the mobile coaching broadcast server begins broadcasting coaching instructions by monitoring geolocations reported by each of the plurality of subscribers and communicating appropriate ones of the available coaching information based on a profiles information associated with each of the plurality of subscribers.

21. The method of claim 17, wherein the mobile coaching broadcast server personalizes the appropriate ones of the available coaching information based on the corresponding subscriber preferences.
